(19) United States
(12) Patent Application Publication
(10) Pub. No.: US 2016/0208537 A1
(43) Pub. Date: Jul. 21, 2016

(54) DOOR PROTECTION SYSTEM

(71) Applicant: JAGUAR LAND ROVER LIMITED, Warwickshire (GB)

(72) Inventors: Ganesh SENGUTTUVAN, Coventry, Warwickshire (GB); Devarshi RATHOD, Coventry, Warwickshire (GB); Carl PICKERING, Warwick, Warwickshire (GB); Paul WIDDOWSON, Kenilworth, Warwickshire (GB); Mark CUND, Inkberrow, Worcestershire (GB)

(21) Appl. No.: 14/898,448

(22) PCT Filed: Jun. 12, 2014
(86) PCT No.: PCT/EP2014/062178

§ 371 Date: Dec. 14, 2015

(30) Foreign Application Priority Data
Jun. 14, 2013 (GB) 1310628.1

(51) Int. Cl. E05F 15/40; B60J 5/04; B60R 1/00

(52) U.S. Cl. CPC E05F 15/40; B60R 1/002; B60J 5/04; E05Y 2900/531; B60R 2300/301; B60Y 2400/902; B60Y 2300/30

(57) ABSTRACT

The present invention relates to a door protection system (1) for protecting the doors (5A-D) of a vehicle (3). The door protection system (1) includes a processor (7) configured to receive obstruction data identifying the position of one or more obstructions (O) in relation to the vehicle (3). The processor (7) determines the proximity of each vehicle door (5A-D) to the obstruction(s) and outputs a notification signal based on the determined proximity. A door position signal can be received from a door position sensor (29A-D) associated with each door (5A-D). The processor (7) can determine the proximity of each vehicle door (5A-D) to the obstruction(s) based on the door position signal in combination with the obstruction data. In an alternate arrangement, the door protection system (1) is configured to monitor one or more vehicle systems to determine when a vehicle occupant is preparing to open the vehicle door (5A-D). The present invention also relates to a vehicle (3) incorporating the door protection system (1) and a related method of protecting a vehicle door (5A-D).

### TECHNICAL FIELD

The present invention relates to a door protection system; a method of protecting a vehicle door; and a vehicle.

### BACKGROUND OF THE INVENTION

There remains a common problem that vehicle doors can be damaged due to inadvertent opening into another object or obstruction. This is a particular problem when there is limited space available, for example in a parking bay where there may be insufficient space available to open fully the vehicle door. It is common practice for vehicle door hinges to define a brake or stop position for holding the vehicle door at an interim position. However, damage may still occur if the vehicle door is opened beyond the stop position. This may occur, for example, if the available space is misjudged by the individual opening the vehicle door.

A related problem is the opening of vehicle doors into the path of oncoming vehicles, such as motor vehicles, motorcycles and bicycles.

At least in certain embodiments, the present invention seeks to overcome or ameliorate problems associated with the prior art arrangements.

### SUMMARY OF THE INVENTION

Aspects of the present invention relate to a door protection system; a method of protecting a vehicle door; and a vehicle.

According to a further aspect of the present invention there is provided a door protection system for a door of a vehicle, the door protection system comprising a processor configured to:
receive obstruction data identifying the position of one or more obstructions in relation to the vehicle;
determine the proximity of the vehicle door to the obstruction(s); and
output a notification signal based on the determined proximity. The notification signal can activate other vehicle systems to provide an alert to an occupant within the vehicle (either the driver or a passenger). The notification signal can thereby help to protect the vehicle door from damage, for example to trigger an alert to notify the vehicle occupant that the vehicle door cannot be fully opened due to the presence of a detected obstruction.

Alternatively, or in addition, the notification signal can activate other vehicle systems to provide an alert to persons outside the vehicle, for example other road users. The notification signal can thereby function as a feature to improve safety.

The processor can be configured to receive a door position signal; and determine the proximity of the vehicle door to the obstruction(s) based on said door position signal in combination with said obstruction data. The door position signal can, for example, indicate an angular orientation of each vehicle door. By referencing a stored dimension file, the extent to which each vehicle door protrudes can be calculated. A comparison can then be made between the current door position and the available space before the door contacts the detected obstruction. The notification signal can be configured to provide an indication of the distance (i.e. the offset) between the vehicle door and the detected obstruction. The notification signal can indicate the distance in a lateral direction arranged orthogonal to a longitudinal axis of the vehicle. The door position signal could be derived from a door position sensor associated with each vehicle door. The door position sensor could comprise a rotary position sensor, a Hall effect sensor or an accelerometer.

The notification signal can, for example, indicate the offset between an outer edge of the vehicle door and the obstruction(s). The processor can be configured to calculate the position of the outer edge of the vehicle door based on the door position signal and stored geometric data relating to the vehicle door. The stored geometric data can, for example, comprise the door length. Alternatively, the processor could access a look-up table to determine the position of the outer edge for a given door position signal.

The obstruction data can identify a longitudinal position and/or a lateral position and/or a vertical position of the obstruction(s) in relation to the vehicle.

The door protection system can comprise one or more sensors for generating said obstruction data. The one or more sensors can have other functions, for example parking distance sensors operative to assist with parking the vehicle. Alternatively, the one or more sensors can comprise dedicated sensors. The one or more sensors can comprise one or more of the following: an ultrasonic sensor; an optical sensor; a laser sensor.

The notification signal can be output to a drive mechanism for inhibiting or restricting opening of the vehicle door. The drive mechanism can be operative to apply a resistive force to the vehicle door. The drive mechanism could be configured to define a hard stop to limit the extent to which the vehicle door can be opened. The drive mechanism can optionally be configured to apply a resistive force which varies in dependence on the proximity of the vehicle door to the obstruction(s). The drive mechanism can be adapted progressively to increase the resistive force as the distance between the vehicle door and the obstruction(s) decreases (i.e. inversely proportional). The notification signal can provide a control signal for controlling operation of the drive mechanism.

In certain applications, an actuator can be provided for assisting with the opening/closing of the vehicle door. The actuator can, for example, comprise an electric machine for opening/closing the vehicle door. The notification signal can control operation of the actuator, for example to inhibit actuation or to adjust an operating speed of the actuator.

The notification signal can be output to an output transducer for generating a user notification. The output transducer can comprise one or more of the following: an audio device; a visual device; and a haptic device. The output transducer can be configured to modify the user notification based on the determined proximity of the vehicle door to the obstruction(s). For example, an audio signal could be modified, for example to increase the frequency and/or volume of audible pips, as the distance between the vehicle door and the obstruction(s) decreases.

The notification signal can be output to a lock mechanism in said vehicle door. The notification signal can optionally cycle said lock mechanism between said locked and unlocked positions. The locking mechanism can be cycled repeatedly between said locked and unlocked positions to provide a user notification. The lock mechanism can be configured to default to an unlocked position at the end of said operating cycle.

The door protection system described herein can be implemented for a vehicle door to provide occupant ingress/egress from the vehicle. Alternatively, or in addition, the door protection system can be implemented for a boot (trunk) door; or a bonnet.

According to a further aspect of the present invention there is provided a door protection system for a door of a vehicle, the door protection system comprising a processor configured to monitor one or more vehicle systems to determine when a vehicle occupant is preparing to open the vehicle door;
wherein the processor is configured, in dependence on the monitoring of said one or more vehicle systems, to generate a notification signal for initiating a notification before the vehicle door is opened.

The processor can be configured to monitor one or more of the following vehicle systems: (a) a door handle sensor for detecting the vehicle occupant making contact with or being in proximity to a door handle on the interior of the vehicle; (b) a seatbelt sensor for determining when a seatbelt mechanism has been released; (c) a vehicle ignition sensor for determining when the vehicle ignition has been switched off; (d) a pressure sensor for monitoring the weight distribution on a vehicle seat; (e) a camera for monitoring the position and/or movements of the vehicle occupant; and (f) a park brake is applied.

The door handle sensor could comprise a proximity sensor, such as a capacitive sensor. The proximity sensor could determine when the occupant's hand is close to, or in contract with the door handle for opening the vehicle door. Alternatively, a sensor could be provided to detect an initial load applied to the door handle or an initial movement of the door handle, for example corresponding to a priming action.

An optical output device can be provided in communication with the processor. The optical output device can be suitable for generating a visible notification in dependence on said notification signal from the processor. The optical output device can be adapted to generate a notification which is visible externally of the vehicle. In other words, the notification can be visible for individuals, such as other road users, from outside the vehicle to provide an advance notice that the vehicle door is about to open. The optical output device could comprise interior cabin lights; or could be disposed on an exterior of the vehicle, for example optical devices mounted to a wing mirror, such as a so-called puddle light. Alternatively, or in addition, a projection system could be disposed on the vehicle or on the vehicle door.

The door protection system can be configured to activate a display screen in dependence on the notification signal. The display screen can be arranged to be visible from inside the vehicle, for example by the occupant opening the vehicle door. The display screen can be disposed on a headrest or a dashboard of the vehicle. The display screen can be configured to display a video image from one or more on-board cameras. The on-board camera(s) can be arranged to provide an image to a rear of the vehicle, for example a rear three quarter view. Alternatively, or in addition, the on-board camera(s) could be arranged to provide an image to a front or to a side of the vehicle. The video image output to the display screen could be selected automatically based on detection of a moving object in the video data for that on-board camera. A composite video image could optionally be created. The on-board camera(s) could, for example, be disposed in a wing mirror, a bumper, a front windscreen (for example behind a rear view mirror), or a rear windscreen. Alternatively, or in addition, a graphical image could be output to the display screen to indicate the type of vehicle detected and/or the relative position of the detected vehicle.

An audio output device can be provided in communication with the processor. The audio output device can be suitable for generating an audible notification in dependence on said notification signal from the processor.

A haptic output device can be provided in communication with the processor. The haptic output device can be suitable for generating a haptic notification in dependence on said notification signal from the processor. The haptic output device can comprise a door lock actuator configured to cycle between unlocked and locked positions in dependence on said notification signal from the processor. The door lock actuator can be configured to default to an unlocked position at the end of said operating cycle. Alternatively, the haptic output device could comprise a mechanical vibrator, for example integrated into the door handle.

The processor can be configured to receive a control signal for identifying that another vehicle is approaching; and estimate a trajectory of the other vehicle. The processor can be configured to model the opening of the vehicle door and to output the notification signal if the modelled lateral opening impinges on the estimated trajectory of the other vehicle.

The processor described herein can comprise one or more electronic microprocessors. The microprocessors can be configured to implement a sequence of instructions to perform the procedure(s) described herein. The sequence of instructions could be defined in hardware or software.

According to a yet further aspect of the present invention there is provided a door protection system for a door of a vehicle, the door protection system comprising a processor configured to:
estimate a trajectory of another vehicle based on a sensor signal; and
generate a notification signal if the estimated trajectory will impinge on the vehicle door. The notification signal can be output if the estimated trajectory will impinge on the vehicle door in its current position; or in a partially open position; or a fully open position. The extent of the vehicle door can, for example, be modelled based on a known geometry of the vehicle door and its current angular position or a fully open position.

The sensor signal can be obtained from one or more sensors configured to detect and track an object (typically a vehicle). The sensor signal can comprise range and angular position data which the processor uses to estimate the vehicle trajectory. The one or more sensors can comprise one or more of the following: radar, lidar, ultrasonics, cameras (optical, infrared etc.), time-in-flight cameras, stereo cameras, passive sonar, capacitance sensing, magnetic field sensing etc.

According to a still further aspect of the present invention there is provided a door protection system for a door of a vehicle, the door protection system comprising a processor configured to monitor one or more vehicle systems to determine when the vehicle door is opening;
wherein the processor is configured, in dependence on the monitoring of said one or more vehicle systems, to display a video image from one or more on-board cameras on a display screen. The one or more vehicle systems can comprise a door actuator, such as a door handle, for opening the vehicle door; and/or a position sensor for measuring a door opening angle. The processor can be configured automatically to display the video image when the door actuator is operated or a change is detected in the door opening angle. The vehicle system could comprise a door handle sensor for determining when the vehicle occupant is in contact with the door handle.

The video image can be displayed as the vehicle door is opened. At least in certain embodiments, the occupant can be provided with an exterior view of the vehicle as the vehicle door is opened. The one or more cameras can be arranged to provide an image to a rear of the vehicle; and/or to a front of the vehicle; and/or to a side of the vehicle. The video image could take the form of a composite image derived from a plurality of cameras.

The display screen can be disposed on a headrest or a dashboard of the vehicle. The display screen can be associated with the vehicle door which is opening. The display screen can be positioned in front of the seat arranged beside that door, for example in the headrest. The processor can be configured to activate the display screen or to change the video signal output to the display screen.

According to a still further aspect of the present invention there is provided a door protection system for a door of a vehicle, the door protection system comprising one or more sensors for detecting an object proximal to said vehicle door and/or approaching said vehicle door;
wherein a processor is configured to generate a notification signal for initiating an occupant alert in dependence on detection of said object before the vehicle door is opened and/or during opening of the vehicle door. At least in certain embodiments, the door protection system can generate an alert to notify a vehicle occupant that an object has been detected. The occupant can take informed steps to avoid opening the door into the object or into the path of said object. The door protection system can provide a supplementary blind spot indicator for the vehicle occupant. The at least one sensor can comprise any of the sensors described herein, including optical, thermal, radar and ultrasonic sensors.

The one or more sensors can be disposed to detect the presence of an object in a blind spot of the occupant, for example to the rear of the vehicle. The one or more sensors can cover a first area into which the vehicle door will open and optionally also a second area disposed to the side and/or rear of the vehicle. The second area can, for example, cover a rear three quarters region of the vehicle.

The door protection system can comprise an output means, connected to the processor, for outputting said occupant alert based on said notification signal. The output means can be a visible output means for outputting a visible alert; and/or an audio output means for outputting an audible alert. The visible output means can, for example, be in the form of an indicator; a warning lamp or light emitting diode; or a display screen. The audible output means can, for example, be in the form of a loudspeaker or other sound generator. The visible output means could, for example, be disposed in the instrument cluster or in a rear view mirror of the vehicle.

The processor could be configured to generate the notification signal in dependence on detection of said object after the vehicle door has been opened, for example to initiate an occupant alert when an object is detected approaching the open vehicle door. The processor could be configured to predict the trajectory of the approaching object in relation to the open vehicle door.

According to a further aspect of the present invention there is provided a vehicle comprising a door protection system of the type described herein.

According to a still further aspect of the present invention there is provided a method of protecting a vehicle door, the method comprising:
monitoring the position of one or more obstructions in relation to the vehicle;
determining the proximity of the vehicle door to said one or more obstructions; and
outputting a notification signal based on the determined proximity.

The method can comprise receiving a door position signal, for example from a door position sensor (such as a rotary position sensor); or a door movement sensor (such as an accelerometer). The proximity of the vehicle door to the one or more obstructions can be determined based on the door position signal in combination with obstruction data indicating the position of said one or more obstructions.

According to a further aspect of the present invention there is provided a method of protecting a vehicle door, the method comprising monitoring one or more vehicle systems to determine when a vehicle occupant is preparing to open the vehicle door; and generating a notification before the vehicle door is opened. The vehicle systems can be configured to monitor the movements and/or behaviour of the vehicle occupant.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

An embodiment of the present invention will now be described, by way of example only, with reference to the accompanying Figures, in which:

FIG. 1 shows a schematic representation of a vehicle incorporating a door protection system in accordance with an embodiment of the present invention;

FIG. 2 illustrates the calculation of the lateral displacement of an outer edge of a vehicle door;

FIG. 3 illustrates the functional relationship between the components of the door protection system shown in FIG. 1; and

FIG. 4 illustrates the type of scenarios in which the door protection system according to an embodiment of the present invention is operative.

### DETAILED DESCRIPTION OF AN EMBODIMENT

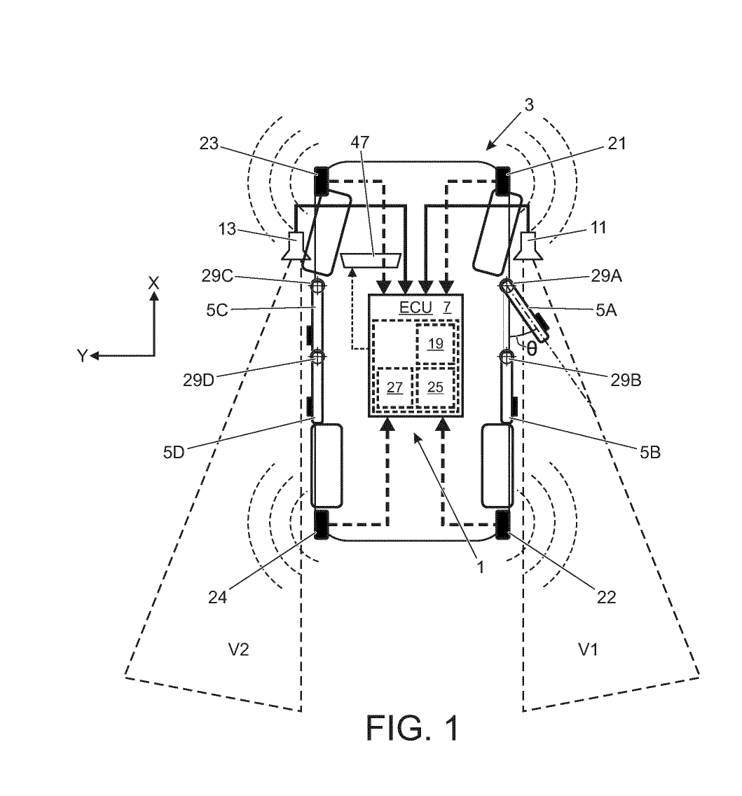

A door protection system 1 for a motor vehicle 3 in accordance with an embodiment of the present invention will now be described with reference to FIGS. 1 to 4. The motor vehicle 3 comprises a plurality of doors 5A-D for occupant ingress/egress. As described herein, the door protection system 1 is operative to protect the doors 5A-D from damage. For example, the door protection system 1 can help reduce the likelihood of a user opening one of the doors 5A-D into a fixed obstruction or into the path of an approaching vehicle.

The door protection system 1 comprises an electronic control unit 7 in communication with first and second optical cameras 11, 13. The optical cameras 11, 13 are disposed in the right and left wing mirrors 15, 17 respectively and are arranged to face towards the rear of the vehicle 3. The image field of each camera 11, 13 encompasses a region extending along the side and to the rear of the vehicle 3, as illustrated by the dashed regions V1, V2 shown in FIG. 1. The cameras 11, 13 thereby capture image data of the regions disposed laterally and behind the vehicle 3. The image data is output to the electronic control unit 7 for analysis by an image processing unit 19 to identify moving objects, such as motor vehicles, motor bikes and bicycles, approaching from the rear of the subject vehicle 3. The door protection system 1 could comprise additional sensors (not shown) for detecting approaching vehicles. The use of radar and/or laser detection systems may be appropriate to provide an increased detection range.

The vehicle 3 also comprises first, second, third and fourth parking sensors 21-24 in communication with a parking assist module 25 provided in the electronic control unit 7. The parking sensors 21-24 can detect objects of interest, such as walls, other vehicle, road/path users etc. The parking sensors 21-24 may generate clutter (noise) which is not attributable to a valid (real) object and this can be filtered by the parking assist module 25. The parking assistance module 25 can also identify objects which don't pose a risk to the vehicle doors 5A-D or the vehicle (these are classed as non-threats). The door protection system 1 seeks to identify those objects which will partially or completely obstruct opening of one or more of the vehicle doors 5A-D and these objects are referred to herein as obstructions. The parking sensors 21-24 in the present embodiment are sonar devices mounted in the front and rear bumpers (not shown) and have an operating range of approximately 2-3 metres. The first and second parking sensors 21, 22 are operative to detect obstructions on the right hand side of the vehicle 3; and the third and fourth parking sensors 23, 24 are operative to detect obstructions on the left hand side of the vehicle 3. It will be appreciated that additional parking sensors can be provided to detect obstructions in front of and behind the vehicle 3.

In the present embodiment, the parking sensors 21-24 are configured to detect the lateral distance dl to obstructions located on each side of the vehicle 3. A measurement signal is output from each parking sensor 21-24 to the electronic control unit 7. The door protection system 1 defines first and second virtual walls W extending parallel to a longitudinal axis X of the vehicle 3 on respective sides of the vehicle 3. The virtual walls W are offset from the side of the vehicle 3 by a distance equal to the smallest lateral distance dl measured by the parking sensors 21-24 on that side of the vehicle 3.

The parking sensors 21-24 can detect the obstruction(s) when the vehicle 3 is stationary. Alternatively, or in addition, the parking sensors 21-24 can detect the obstruction(s) as the vehicle 3 is parked. The parking sensors 21-24 can detect the obstruction(s) as the vehicle 3 decelerates and comes to a standstill temporarily or for a short period of time, for example to allow an occupant to exit the vehicle 3. For example, the parking sensors 21-24 could be activated to identify said obstruction(s) as the vehicle 3 is parked under the automated control of the parking assist module 25.

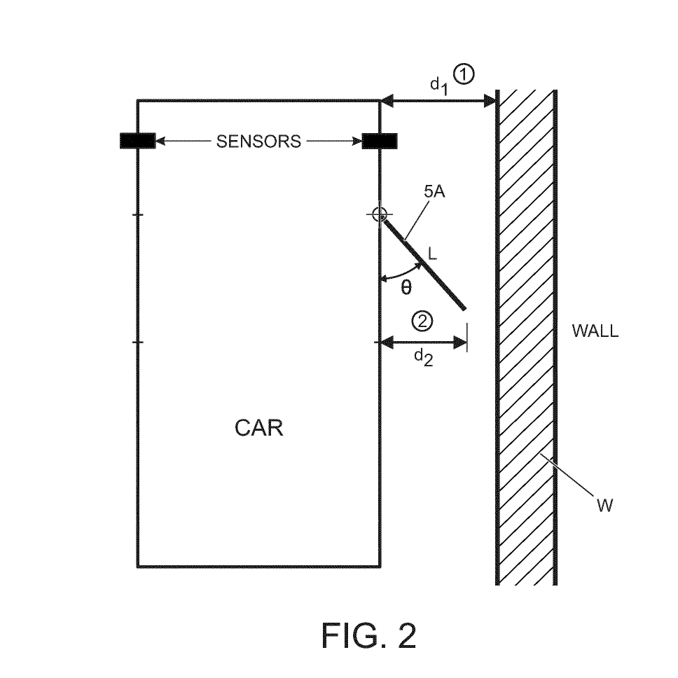

The electronic control unit 7 comprises a storage device in the form of memory 27 in which vehicle dimensions, including the length of each door 5A-D, are stored. The door opening angle θ is measured by angular sensors 29A-D associated with each door 5A-D and output to the electronic control unit 7. The angular sensors 29A-D can, for example, comprise a rotary position sensor or a Hall effect sensor. The position of the door 5A-D in relation to the virtual wall W defined on that side of the vehicle 3 can be calculated by the electronic control unit 7. As illustrated in FIG. 2, a lateral offset d2 of an outer edge of the door 5A-D can be determined by the trigonometric function Sin θ=d2/L, where L is the known length of the door 5A-D and θ is the measured door opening angle.

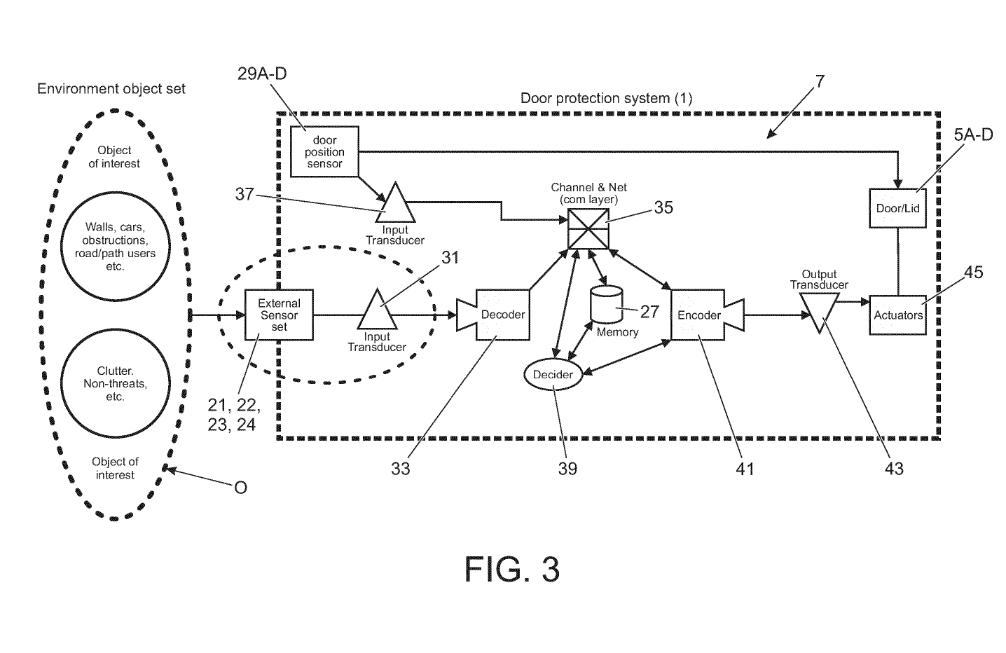

The operation of the door protection system 1 will now be described with reference to FIG. 3. The door protection system 1 is represented schematically and the transfer of data between the modules within the electronic control unit 7 is illustrated by transfer arrows. For the sake of brevity, the operation will be described with reference to the first door 5A disposed on the right hand side of the vehicle 3. It will be appreciated that the same techniques can be implemented for each of the other doors 5B-D.

The first and second parking sensors 21, 22 are operative to detect one or more obstructions O positioned on the right hand side of the vehicle 3. The first and second parking sensors 21, 22 output respective first and second detection signals to a first input transducer 31 provided in the electronic control unit 7. The first input transducer 31 transmits the detection signals to a decoder 33 which decodes the detection signals to generate distance data corresponding to the distance between the vehicle 3 and each obstruction O identified by the first and second parking sensors 21, 22. The decoder 33 publishes the distance data to a communication network 35, such as a vehicle Controller Area Network (CAN) bus.

The first angular sensor 29A is operative to measure the door opening angle θ of the first door 5A. The first angular sensor 29A outputs an angular signal to a second input transducer 37. The second input transducer 37 publishes angular data to the communication network 35 corresponding to the door opening angle θ.

A decision module 39 retrieves the distance data and the angular data from the communication network 35. The decision module 39 identifies the smallest lateral distance d1 between the vehicle 3 and an obstruction identified by the first and second parking sensors 21, 22. The decision module 39 defines the virtual wall W at a lateral position corresponding to the smallest lateral distance d1 on that side of the vehicle 3. This process is repeated for both sides of the vehicle 3 to define the relative positions of the first and second virtual walls W. The decision module 39 interrogates the memory 27 to determine the length L of the first door 5A. Using the trigonometry techniques described herein, the decision module 39 calculates the lateral offset d2 of an outer edge of the first door 5A. A comparison is made between the lateral distance d1 and the lateral offset d2 of the outer edge of the door 5A. The decision module 39 generates a notification signal based on the comparison and the notification signal is output to an encoder 41 and an encoded signal is transmitted to an output transducer 43. The output transducer 43 is configured to control an actuator 45 disposed with the first door 5A. The actuator 45 is operative to control the opening of the first door 5A, for example by applying a resistive force to inhibit opening, if the lateral offset d2 approaches the lateral distance d1. The magnitude of the resistive force could be inversely proportional to the determined difference between the lateral distance d1 and the lateral offset d2. Alternatively, or in addition, the difference between the lateral distance d1 and the lateral offset d2 could be calculated and the actuator 45 operated when the difference is less than or equal to a predefined threshold.

The first angular sensor 29A continues to monitor the door opening angle θ. The first and second parking sensors 21, 22 continue to detect the presence of obstructions and can update the position of the virtual wall W in relation to the vehicle 3 substantially in real time. For example, if the measured distance to the nearest obstruction increases or decreases, the position of the virtual wall can be modified accordingly. In use, the decision module 39 can receive feedback from both the first angular sensor 29A and the first and second parking sensors 21, 22. The actuator 45 is controlled in dependence on the output from the encoder 41.

The door protection system 1 can optionally be configured to activate a display screen 47 to display a video image from one or both of the cameras 11, 13. The display screen 47 can be positioned on a headrest or a dashboard of the vehicle 3. The door protection system 1 can be configured to monitor on-board vehicle systems to predict when an occupant will open one of the doors 5A-D to exit the vehicle 3. For example, the door protection system 1 can be activated by detection of a hand proximal to the door handle and/or unbuckling of a seat belt. Upon detection of an action indicative of the occupant preparing to exit the vehicle, the door protection system 1 can automatically activate the display screen 47 to display the video image from the video camera(s) 11, 13. The door protection system 1 can thereby provide the occupant with an alternate view of the exterior of the vehicle before the vehicle door 5A-D is opened. The door protection system 1 could be configured to select which video image is displayed based on detection of a moving object in the video image. Alternatively, a particular camera 11, 13 could be associated with each door 5A-D and the video image from that camera 11, 13 displayed when the door protection system 1 determines that the occupant is about to open the door 5A-D. The door protection system 1 could be activated only when the vehicle 3 is stationary. The door protection system 1 could be modified to output the video image from an exterior camera 1, 13 as the vehicle door 5A-D is opened, for example when the door handle is operated and/or a change in the door opening angle θ is detected.

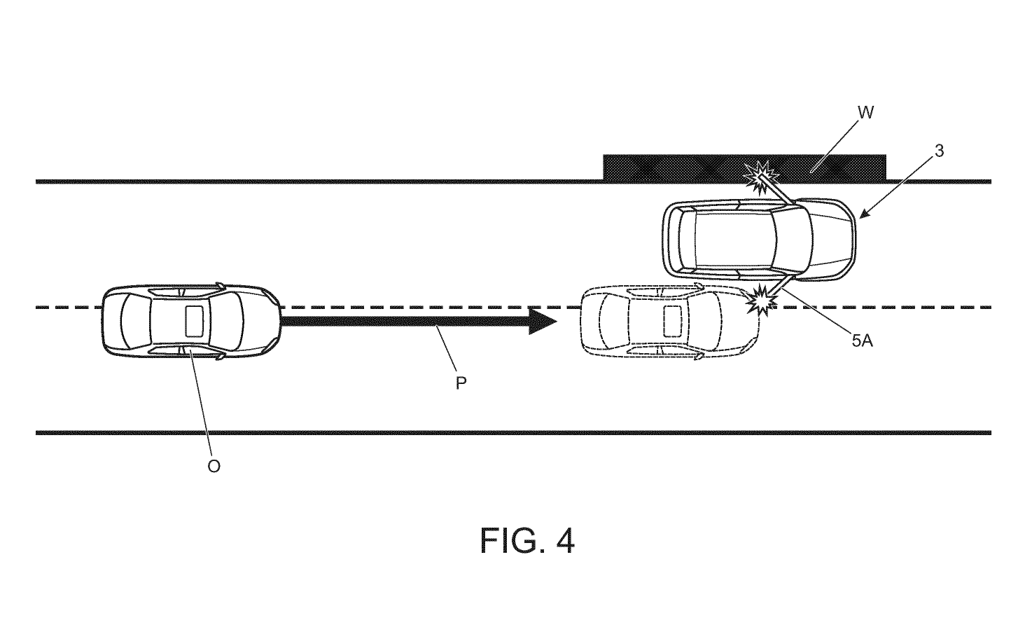

The door protection system 1 can also be configured to utilise the image data from the first and second cameras 11, 13 to protect the vehicle doors 5A-D. The image data from the cameras 11, 13 can be output to the electronic control unit 7 for analysis by the image processing unit 19. The image processing unit 19 is configured to identify moving objects within the image data and can predict a trajectory or path P of the object, as illustrated in FIG. 4. The decision module 39 determines if the vehicle door 5A will open into the predicted path P of the object and, if so, a notification signal is output to the encoder 41. The encoder 41 transmits an encoded signal to the output transducer 43 which is configured to control the actuator 45. The actuator 45 is operative to control the opening of the first door 5A, for example by applying a resistive force to inhibit opening.

It will be appreciated that various changes and modifications can be made to the door protection system 1 described herein without departing from the present invention. For example, the embodiment has been described with particular reference to the vehicle doors 5A-D configured for occupant ingress/egress to the vehicle. In alternate embodiments, the door protection system 1 could be configured to protect other vehicle doors, such as an engine cover (bonnet) 7 and/or a trunk (boot) door 9.

Further aspects of the present invention are set out in the following set of numbered paragraphs:

1. A door protection system for a door of a vehicle, the door protection system comprising a processor configured to:
receive obstruction data identifying the position of one or more obstructions in relation to the vehicle;
determine the proximity of the vehicle door to the obstruction(s); and
output a notification signal based on the determined proximity.

2. A door protection system as described in paragraph 1, wherein the processor is configured to:
receive a door position signal; and
determine the proximity of the vehicle door to the obstruction(s) based on said door position signal in combination with said obstruction data.

3. A door protection system as described in paragraph 2, wherein the notification signal is indicative of an offset between the vehicle door and the obstruction(s).

4. A door protection system as described in paragraph 3, wherein the notification signal indicates the offset between an outer edge of the vehicle door and the obstruction(s).

5. A door protection system as described in paragraph 4, wherein the processor is configured to calculate the position of the outer edge of the vehicle door based on the door position signal and stored geometric data relating to the vehicle door.

6. A door protection system as described in paragraph 1, wherein the obstruction data identifies a longitudinal position and/or lateral position and/or vertical position of the obstruction(s) in relation to the vehicle.

7. A door protection system as described in paragraph 1 comprising one or more sensors for outputting said obstruction data to the processor.

8. A door protection system as described in paragraph 7, wherein said one or more sensors comprise one or more of the following: an ultrasonic sensor; an optical sensor; a laser sensor.

9. A door protection system as described in paragraph 1, wherein the notification signal is output to a drive mechanism for inhibiting or restricting opening of the vehicle door.

10. A door protection system as described in paragraph 9, wherein the drive mechanism applies a resistive force to the vehicle door; the resistive force optionally being varied in dependence on the proximity of the vehicle door to the obstruction(s).

11. A door protection system as described in paragraph 1, wherein the notification signal is output to an output transducer for generating a user notification.

12. A door protection system as described in paragraph 11, wherein the output transducer comprises one or more of the following: an audio device; a visual device; and a haptic device.

13. A door protection system as described in paragraph 12, wherein the output transducer is configured to modify the user notification based on the determined proximity of the vehicle door to the obstruction(s).

14. A door protection system as described in paragraph 1, wherein the notification signal is output to a lock mechanism in said vehicle door, the notification signal optionally cycling said lock mechanism between unlocked and locked positions.

15. A door protection system as described in paragraph 1, wherein the vehicle door is for vehicle occupant ingress/egress; or a boot (trunk) lid; or a bonnet.

16. A door protection system for a door of a vehicle, the door protection system comprising a processor configured to monitor one or more vehicle systems to determine when a vehicle occupant is preparing to open the vehicle door;
wherein the processor is configured, in dependence on the monitoring of said one or more vehicle systems, to generate a notification signal for initiating a notification before the vehicle door is opened.

17. A door protection system as described in paragraph 16, wherein the processor is configured to monitor one or more of the following vehicle systems:
(a) a door handle sensor for detecting the vehicle occupant making contact with or being in proximity to a door handle on the interior of the vehicle;
(b) a seatbelt sensor for determining when a seatbelt mechanism has been released;
(c) a vehicle ignition sensor for determining when the vehicle ignition has been switched off;
(d) a pressure sensor for monitoring the weight distribution on a vehicle seat;
(e) a camera for monitoring the position and/or movements of the vehicle occupant; and
(f) a park brake is applied.

18. A door protection system as described in paragraph 16, comprising an optical output device in communication with the processor, the optical output device being suitable for generating a visible notification in dependence on said notification signal from the processor.

19. A door protection system as described in paragraph 18, wherein the optical output device is adapted to generate a visible notification which is visible externally of the vehicle.

20. A door protection system as described in paragraph 16 comprising a display screen for displaying a video image from an on-board camera, the display screen being configured to be activated in dependence on said notification signal.

21. A door protection system as described in paragraph 20, wherein the display screen is disposed on a headrest or a dashboard of the vehicle.

22. A door protection system as described in paragraph 20, wherein the on-board camera is arranged to provide an image to a rear of the vehicle; to a front of the vehicle; to a side of the vehicle.

23. A door protection system as described in paragraph 16, comprising an audio output device in communication with the processor, the audio output device being suitable for generating an audible notification in dependence on said notification signal from the processor.

24. A door protection system as described in paragraph 16, comprising a haptic output device in communication with the processor, the haptic output device being suitable for generating a haptic notification in dependence on said notification signal from the processor.

25. A door protection system as described in paragraph 24, wherein the haptic output device comprises a door lock actuator configured to cycle through unlocked and locked positions in dependence on said notification signal from the processor.

26. A door protection system as described in paragraph 16, wherein the processor is configured to:
receive a control signal for identifying that another vehicle is approaching; and
estimating a trajectory of the other vehicle.

27. A door protection system as described in paragraph 26, wherein the processor is configured to model the lateral opening of the vehicle door and to output said notification signal if the modelled lateral opening impinges on the estimated trajectory of the other vehicle.

28. A door protection system for a door of a vehicle, the door protection system comprising a processor configured to:
estimate a trajectory of another vehicle based on a sensor signal; and
generate a notification signal if the estimated trajectory will impinge on the vehicle door.

29. A door protection system for a door of a vehicle, the door protection system comprising a processor configured to monitor one or more vehicle systems to determine when the vehicle door is opening;
wherein the processor is configured, in dependence on the monitoring of said one or more vehicle systems, to display a video image from one or more on-board cameras on a display screen.

30. A door protection system as described in paragraph 29, wherein the display screen is disposed on a headrest or a dashboard of the vehicle.

31. A door protection system as described in paragraph 29, wherein said one or more on-board cameras are arranged to provide an image to a rear of the vehicle; and/or to a front of the vehicle; and/or to a side of the vehicle.

32. A door protection system for a door of a vehicle, the door protection system comprising one or more sensors for detecting an object proximal to said vehicle door and/or approaching said vehicle door;
wherein a processor is configured to generate a notification signal for initiating an occupant alert in dependence on detection of said object before the vehicle door is opened and/or during opening of the vehicle door.

33. A door protection system as claimed in claim 32 comprising an output means connected to said processor and configured to output an audible alert and/or a visible alert upon receipt of said notification signal.

34. A vehicle comprising a door protection system as described in any one of the preceding claims.

35. A method of protecting a vehicle door, the method comprising:
monitoring the position of one or more obstructions in relation to the vehicle;
determining the proximity of the vehicle door to said one or more obstructions; and
outputting a notification signal based on the determined proximity.

36. A method as described in paragraph 35 comprising receiving a door position signal; and determining the proximity of the vehicle door to the one or more obstructions based on the door position signal in combination with the obstruction data indicating the position of said one or more obstructions.

37. A method of protecting a vehicle door, the method comprising monitoring one or more vehicle systems to determine when a vehicle occupant is preparing to open the vehicle door; and generating a notification before the vehicle door is opened.

1-28. (canceled)

29. A door protection system for a door of a vehicle, the door protection system comprising a processor configured to monitor one or more vehicle systems to determine when the vehicle door is opening or when a vehicle occupant is preparing to open the door;
wherein the processor is configured, in dependence on the monitoring of said one or more vehicle systems, to display a video image from one or more on-board cameras on a display screen disposed on a headrest of the vehicle.

30. (canceled)

31. A door protection system as claimed in claim 29, wherein said one or more on-board cameras are arranged to provide an image to a rear of the vehicle; and/or to a front of the vehicle; and/or to a side of the vehicle.

32. A door protection system as claimed in claim 29, the door protection system comprising one or more sensors for detecting an object proximal to said vehicle door and/or approaching said vehicle door;
wherein the processor is configured to display the video image in dependence on detection of said object before the vehicle door is opened and/or during opening of the vehicle door.

33. A door protection system as claimed in claim 32 comprising an output means connected to said processor and configured to output an audible alert and/or a haptic alert when the video image is displayed.

34. A vehicle comprising a door protection system as defined in claim 29.

35-39. (canceled)

40. A door protection system as claimed in claim 29, wherein said one or more sensors comprise one or more of the following: an ultrasonic sensor; an optical sensor; a laser sensor.

41. A door protection system as claimed in claim 29, wherein the processor is configured to monitor one or more of the following vehicle systems:
(a) a door handle sensor for detecting the vehicle occupant making contact with or being in proximity to a door handle on the interior of the vehicle;
(b) a seatbelt sensor for determining when a seatbelt mechanism has been released;
(c) a vehicle ignition sensor for determining when the vehicle ignition has been switched off;
(d) a pressure sensor for monitoring the weight distribution on a vehicle seat;
(e) a camera for monitoring the position and/or movements of the vehicle occupant; and
(f) a park brake is applied.

42. A door protection system as claimed in claim 1, wherein the processor is configured to:
receive a control signal for identifying that another vehicle is approaching; and
estimating a trajectory of the other vehicle;
optionally the processor is configured to model the lateral opening of the vehicle door and to display the visual image if the modelled lateral opening impinges on the estimated trajectory of the other vehicle.

43. A door protection system for a door of a vehicle, the door protection system comprising a processor configured to:
receive obstruction data identifying the position of one or more obstructions in relation to the vehicle;
determine the proximity of the vehicle door to the obstruction(s); and
output a notification signal based on the determined proximity, wherein the notification signal is output to a drive mechanism for inhibiting or restricting opening of the vehicle door and cases the drive mechanism to apply a resistive force to the vehicle door; the resistive force being varied in dependence on the proximity of the vehicle door to the obstruction(s).

44. A door protection system as claimed in claim 43, wherein the processor is configured to:
receive a door position signal; and
determine the proximity of the vehicle door to the obstruction(s) based on said door position signal in combination with said obstruction data.

45. A door protection system as claimed in claim 44, wherein the notification signal is indicative of an offset between the vehicle door and the obstruction(s).

46. A door protection system as claimed in claim 45, wherein the notification signal indicates the offset between an outer edge of the vehicle door and the obstruction(s).

47. A door protection system as claimed in claim 46, wherein the processor is configured to calculate the position of the outer edge of the vehicle door based on the door position signal and stored geometric data relating to the vehicle door.

48. A door protection system as claimed in claim 43, wherein the obstruction data identifies a longitudinal position and/or lateral position and/or vertical position of the obstruction(s) in relation to the vehicle.

49. A door protection system as claimed in claim 43 comprising one or more sensors for outputting said obstruction data to the processor.

50. A door protection system as claimed in claim 43, wherein the notification signal is output to an output transducer comprising one or more of the following: an audio device; a visual device; and a haptic device, for generating a user notification.

51. A door protection system as claimed in claim 50, wherein the output transducer is configured to modify the user notification based on the determined proximity of the vehicle door to the obstruction(s).

52. A door protection system as claimed in claim 43, wherein the notification signal is output to a lock mechanism in said vehicle door, the notification signal optionally cycling said lock mechanism between unlocked and locked positions.

53. A vehicle comprising a door protection system as defined in claim 43.

54. A method of protecting a vehicle door, the method comprising:
monitoring one or more vehicle systems to determine when the vehicle door is opening or a vehicle occupant is preparing to open the door; and
displaying a video image from one or more on-board cameras on a display screen disposed on a headrest of the vehicle in dependence on the monitoring of said one or more vehicle systems.
